(19) United States
(12) Patent Application Publication
(10) Pub. No.: US 2025/0270419 A1
(43) Pub. Date: Aug. 28, 2025

(54) TWO-PART HYBRID EPOXY-POLYURETHANE COATINGS SYSTEM AND COATINGS FORMED THEREFROM

(71) Applicant: SWIMC LLC, Cleveland, OH (US)

(72) Inventors: Liang LIANG, Twinsburg, OH (US); Chaohui ZHOU, Solon, OH (US); Zhiqi YANG, Solon, OH (US); Wei CHEN, Hudson, OH (US); Scott T. SMALLEY, Mentor, OH (US); Travis SMITH, North Royalton, OH (US); Gordon A. BORU, Cleveland, OH (US)

(21) Appl. No.: 19/058,524

(22) Filed: Feb. 20, 2025

Related U.S. Application Data
(60) Provisional application No. 63/556,619, filed on Feb. 22, 2024.

(51) Int. Cl. C09D 175/04; C09D 5/00; C09D 163/00

(52) U.S. Cl. CPC C09D 175/04; C09D 5/002; C09D 163/00

(57) ABSTRACT

A two-part coatings system is provided. The system includes a resin component and a crosslinking component. The resin component includes a mixture of an epoxy resin and a polyurethane resin. The crosslinking component includes a curing agent and a catalyst. The polyurethane resin includes a donor for a Michael addition reaction and an acceptor for a Michael addition reaction. The catalyst is configured to facilitate a Michael addition reaction between the donor and the acceptor of the polyurethane resin. The curing agent is configured to react with the epoxy resin.

### CROSS REFERENCE TO RELATED APPLICATIONS

The present application is related to, and claims priority to, U.S. Provisional Application Ser. No. 63/556,619, filed Feb. 22, 2024, the contents of which are hereby incorporated by reference in their entirety.

### TECHNICAL FIELD

The present invention relates to a two-part coatings system that forms a hybrid, interpenetrating network of epoxy resin and a polyurethane resin upon a reaction between a resin component and a crosslinking component; coatings formed therefrom; and methods of making the same.

### BACKGROUND OF THE INVENTION

The US paint and coatings industry includes more than 1,000 companies with combined annual sales in excess of $20 billion and continues to grow. Typical coatings used for indoor applications, such as on drywall in a house, comprise a waterborne latex. Such waterborne latex coatings at least include a polymer dispersed in water. Upon applying a waterborne latex-based coating to a substrate, the water evaporates, and the remaining polymer coalesces to form a continuous, cured film on the substrate. Though waterborne latex-based coatings are low-cost, easy to apply to a surface, easy to cleanup, and have low VOCs, drying of waterborne latex-based coatings vary depending on the humidity and temperature of the application surface and surrounding environment. Additionally, dried waterborne latex-based coatings are prone to scratches and cracking.

To achieve a highly protective coating that is less prone to scratching, cracking, and other damage by various environmental conditions (e.g., humidity, temperature, sunlight, etc.), polyurethane-based coatings may be used. For example, a polyurethane-based coating may be used on vehicles, wood furniture, outdoor surfaces, indoor trim, marine applications, or other surfaces that are exposed to harsh conditions. One-component polyurethane coatings cure by crosslinking when exposed to water and/or heat. In two-component polyurethane coatings, a first component is mixed with a second component before applying the coating to a surface. Two-component polyurethane coatings typically do not require water or heat for curing, and instead may depend on the specific ratio of components mixed together and/or a crosslinker agent in the two-component polyurethane system for curing. Although two-component polyurethane coatings may have higher mechanical properties compared to one-component polyurethane systems, there are environmental, health, and safety concerns associated with the reaction upon mixing the two components to form a cured, two-component polyurethane coating.

### SUMMARY OF THE INVENTION

Accordingly, one object of the present invention is to provide a two-part coatings system that is waterborne and that does not comprise or is substantially free of free isocyanates to improve environmental effects of the two-part coatings system during mixing and curing.

A further object of the present invention is to provide a two-part coatings system form from a resin component and a crosslinking component. The resin component comprises a polyurethane resin and an epoxy resin. The crosslinking component comprises a curing agent and a catalyst. The polyurethane resin includes a donor for a Michael addition reaction and an acceptor for a Michael addition reaction. The catalyst is configured to facilitate a Michael addition reaction between the donor and the acceptor of the polyurethane resin. The curing agent is configured to react with the epoxy resin. When the resin component and the crosslinking component are mixed together and applied to a substrate, a cured coating is formed comprising a first polymer network of crosslinked polyurethane and a second polymer network of crosslinked epoxy. The first polymer network is interlaced but not crosslinked with the second polymer network to form an interpenetrating polymer network. This way, the cured coating has favorable properties from the epoxy and also from the polyurethane, while still having a controlled molecular weight for a coatings application.

Another object of the present invention is to provide a method. The method includes mixing a resin component with a crosslinking component. The resin component includes an epoxy resin and a polyurethane resin. The crosslinking component includes a curing agent and a catalyst. The mixture of the resin component and the crosslinking component is then applied on a substrate. The mixture cures to form a cured hybrid epoxy-polyurethane coating on the substrate. The mixture cures as the curing agent reacts with the epoxy resin and as the catalyst reacts with the polyurethane resin to form an interpenetrating polymer network over the substrate.

These and other objects of this invention, alone or in combination, have been satisfied by the discovery of a two-part, hybrid epoxy-polyurethane system comprising a resin component and a crosslinking component. The hybrid epoxy-polyurethane system and coating composition made therefrom will be further described in the following detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates a schematic of some embodiments of an interpenetrating polymer network formed from a two-component system upon a reaction between a resin component and a crosslinking component as described herein.

### DETAILED DESCRIPTION OF THE INVENTION

The recitation of a numerical range using endpoints includes all numbers subsumed within that range (e.g., 1 to 5 includes 1, 1.5, 2, 2.75, 3, 3.80, 4, 5, etc.).

To the extent that the terms “including”, “includes”, “having”, “has”, “with”, or variants thereof are used in the present application, such terms are intended to be inclusive in a manner similar to the term “comprising.” The singular forms “a”, “an” and “the” include plural referents unless the context clearly dictates otherwise. Additionally, the terms “a,” “an,” “the,” “at least one,” and “one or more” are used interchangeably. Thus, for example, a coating composition that contains “an” additive means that the coating composition can include “one or more” additives. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

The term “comprises” and variations thereof do not have a limiting meaning where these terms appear in the description and claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The term “acrylic” as used herein includes (meth)acrylic acid, (meth)alkyl acrylate, (meth)acrylamide, (meth)acrylonitrile and their modified forms such as (meth)hydroxyalkyl acrylate. Throughout this document, the word fragment “(meth)acryl” refers to both “methacryl” and “acryl”. For example, (meth)acrylic acid refers to both methacrylic acid and acrylic acid, and methyl (meth)acrylate refers to both methyl methacrylate and methyl acrylate.

The term “aliphatic” when used in the context of a carbon-carbon double bond includes both linear (or open chain) aliphatic carbon-carbon double bonds and cycloaliphatic carbon-carbon double bonds, but excludes aromatic carbon-carbon double bonds of aromatic rings.

The term “aqueous” composition or dispersion herein means that particles are dispersed in an aqueous medium. An “aqueous medium” herein has a continuous phase of water that makes up at least 50 weight percent of the aqueous medium, wherein the remaining composition of the aqueous medium comprises particles and water-miscible compound(s) such as, for example, alcohols, glycols, glycol ethers, glycol esters, and the like.

The term “(co)polymer” as used herein includes both homopolymers (polymers containing units from a single monomer) and copolymers (polymers containing units from two or more different monomers), unless otherwise specifically stated.

The term “crosslinker” or “crosslinking component” as used herein refers to at least one molecule capable of forming a covalent linkage between polymers or between two different regions of the same polymer.

The term “on,” when used in the context of a coating applied on a substrate, includes both coatings applied directly or indirectly to the substrate. Thus, for example, a coating applied to a primer layer overlying a substrate constitutes a coating applied on the substrate.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As used herein, the term “structural units,” also known as polymerized units, of the named monomer refers to the remnant of the monomer after polymerization, or the monomer in polymerized form.

Within the context of the present invention, the term “waterborne” is intended to mean that the polymeric components are in an aqueous medium. In certain embodiments, waterborne coatings provide one or more of the following advantages: low toxicity and flammability due to low VOC levels and low HAP emissions; lower cost than solvent-borne coatings and no additives, thinners, or hardeners are required in most cases; less coating is required to cover the same surface area as compared to the use of solventborne coating solutions; and paint guns can be readily cleaned with water or water-based solutions and do not require paint thinner, acetone, or methyl acetate (further environmentally friendly and user safety friendly).

The present invention relates to the formulation of hybrid waterborne primer systems, methods used to prepare the primer coatings, and their use as coatings on substrates. The hybrid waterborne primers of the invention can be used alone as a direct-to-substrate primer or in combination with a surface treatment on the substrate to be coated, such as an etching primer or other chemical surface treatment to render the surface of the substrate better able to receive and bond with the hybrid waterborne primer of the invention.

Embodiments of the invention disclosed herein relate to a two-part coatings system. The two-part coatings system may be used in any desired end use, including, but not limited to, the architectural, automotive, construction, marine, aerospace, and similar industries. As will be described further herein, the two-part coatings system comprises a resin component and a crosslinking component. Each component provides various properties. The resin component comprises an epoxy resin and a polyurethane resin. The crosslinking component comprises a curing agent configured to react with the epoxy resin upon mixing and a catalyst configured to react with the polyurethane resin upon mixing. When the resin component and the crosslinking component are mixed together, the two components react to form a cured, hybrid epoxy-polyurethane coating. This hybrid epoxy-polyurethane coating has a balance of favorable properties attributable to the polyurethane resin and the epoxy resin (e.g., chemical resistance, mechanical properties, weatherability, cure rates, potlife, anti-corrosion, etc.). Additionally, the hybrid epoxy-polyurethane coating cures without the use of isocyanates, thereby eliminating the carbon dioxide byproduct. Without this carbon dioxide byproduct, the hybrid epoxy-polyurethane coatings system has lower VOCs and also has more favorable mechanical properties compared to a polyurethane coatings system comprising isocyanates.

The polyurethane resin comprises a donor for a Michael addition reaction and an acceptor for a Michael addition reaction within the polyurethane polymer chain. The epoxy resin may be mixed with the polyurethane resin to form the resin component. The epoxy resin and the polyurethane resin may both be waterborne. The epoxy resin is substantially unreactive or more preferably unreactive with the polyurethane resin. “Substantially unreactive with” means that if any reactions did occur after mixing two or more polymers together, then the number of reactions between the polymers are so few and insignificant that the overall viscosity of the mixture remains below 120 Krebs units after being stored for 20 days at 40 degrees Celsius. This viscosity limit indicates that no gelling has occurred, and thus, the resin component is still usable for coating applications with consistent performance properties.

Because the polyurethane resin includes the donor and acceptor for a Michael addition reaction, production of carbon dioxide from the polyurethane is reduced or more preferably eliminated. As such, there is little or more preferably no amine groups in the polyurethane resin that, when mixed with the epoxy resin to form the resin component, act as a catalyst to polymerize the epoxy resin. Therefore, when the polyurethane resin comprising the donor and acceptor for a Michael addition reaction is mixed with the epoxy resin to form the resin component, the epoxy resin and the polyurethane are substantially unreactive or more preferably unreactive with one another. Thus, substantially no crosslinking or more preferably no crosslinking occurs amongst the polyurethane polymer chains, amongst the epoxy polymer chains, or between polyurethane polymer chains and epoxy polymer chains. “Substantially no crosslinking” corresponds to embodiments where the epoxy resin and the polyurethane resin were substantially unreactive with one another upon mixing to form the resin component.

In some embodiments, about 5 wt % to about 45 wt %, more preferably about 5 wt % to about 40 wt %, about 5 wt % to about 35 wt %, about 10 wt % to about 45 wt %, about 10 wt % to about 40 wt %, about 10 wt % to about 35 wt %, about 10 wt % to about 30 wt %, or even more preferably about 10 wt % to about 25 wt % of the resin component comprises the epoxy resin, with the remaining part of the resin component comprising the polyurethane resin. As the amount of epoxy resin in the resin component increases, the greater the viscosity of the resin component becomes. For example, in some embodiments wherein about 15 wt % of the resin component comprises the epoxy resin, the resin component has a viscosity of about 75 Krebs units using ASTM D562-10 after about 20 days at 40 degrees Celsius, while in some other embodiments wherein about 30 wt % of the resin component comprises the epoxy resin, the resin component has a viscosity of about 100 Krebs units after about 20 days at 40 degrees Celsius. In either embodiment, the resin component still has a viscosity that is less than 120 Krebs units after being stored for 20 days at 40 degrees Celsius, thereby indicating that the epoxy resin and the polyurethane resin are substantially unreactive or more preferably unreactive when mixed together to form the resin component.

In the crosslinking component, the curing agent and the catalyst are substantially unreactive or more preferably, completely unreactive with one another. In some embodiments, the curing agent comprises amines, and the catalyst comprises functional groups that facilitate a Michael addition reaction with the polyurethane resin. Because the polyurethane resin disclosed herein uses a Michael addition reaction for crosslinking within the polyurethane resin, free isocyanates can be eliminated from the system, which is beneficial as free isocyanates otherwise would react with the amine curing agents, thereby making the crosslinking component unstable. Thus, the catalyst does not comprise isocyanates and is therefore substantially unreactive or more preferably completely unreactive with the epoxy resin, and the curing agent is substantially unreactive or more preferably completely unreactive with the polyurethane resin. In some embodiments, the viscosity of the crosslinking component remains substantially unchanged over time upon mixing after 36 days and stored at 40 degrees Celsius. For example, in some implementations, the viscosity of the crosslinking component only varies within about 5 Krebs units over time. In some implementations, the viscosity of the crosslinking component may be in a range of between about 35 Krebs units and about 50 Krebs units, for example. If the viscosity of the crosslinking component is too high, then water can be added to the crosslinking component to reduce the viscosity. Because the curing agent and the catalyst are not consumed upon mixing and storing the crosslinking component, when the crosslinking component is mixed with the resin component, the curing agent and the catalyst are still available to react with the resin component. Upon mixing the resin component with the crosslinking component, the polyurethane resin crosslinks with itself, and the epoxy resin crosslinks with itself thereby forming an interpenetrating polymer network.

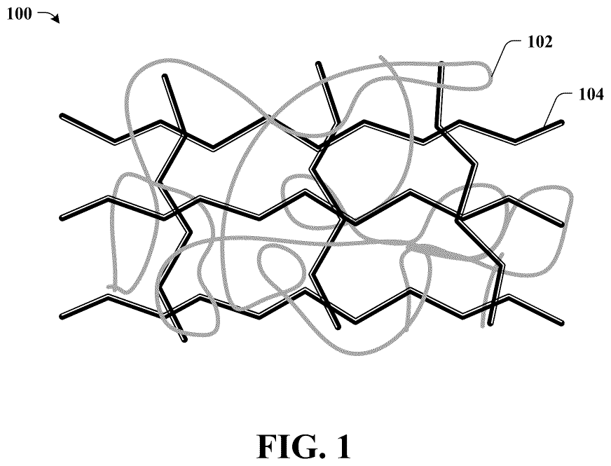

FIG. 1 presents a schematic of some embodiments of an interpenetrating polymer network 100. The interpenetrating polymer network 100 comprises an interlaced network of the crosslinked polyurethane resin 102 and the crosslinked epoxy resin 104, where the crosslinked polyurethane resin 102 and the crosslinked epoxy resin 104 are entangled and penetrate with one another but are substantially not or more preferably are not crosslinked with one another. In other words, while the crosslinked epoxy network 104 may be mechanically connected through entanglement with the crosslinked polyurethane network 102, the two networks are not chemically connected. This mechanical reinforcement between the crosslinked epoxy network 104 and the crosslinked polyurethane network 102 may provide better mechanical and chemical resistance properties than each crosslinked network individually. For example, in some embodiments, the interpenetrating polymer network 100 comprising the hybrid epoxy-polyurethane system disclosed herein may have a better corrosion resistance than an epoxy system alone or than a polyurethane system alone. In some other embodiments, a partial interpenetrating polymer network 100 may be formed where a small number of crosslinks occur between the crosslinked polyurethane resin and the crosslinked epoxy resin 104.

The reaction between the amines and the epoxy resin is based on an opening-ring reaction to develop the crosslinked epoxy network 104, whereas the reaction between the catalyst and the polyurethane resin is based on a Michael Addition reaction to develop the crosslinked polyurethane network 102. Because these reaction mechanisms are very different from one another, substantially no or more preferably, no crosslinking occurs between the crosslinked epoxy network 104 and the crosslinked polyurethane network 102 when the resin component is mixed with the crosslinking component. Because the two different reactions are substantially unreactive with one another, the final properties of the interpenetrating polymer network 100 and coatings formed therefrom can be tuned more easily because when the reaction of one of the resins is adjusted to achieve a particular property, the reaction of the other resin may not change or may not significantly change.

Additionally, because the two reactions are substantially unreactive with one another, the rate of reactions may be different. For example, in some embodiments, the rate of the opening-ring reaction between the epoxy resin and the amine curing agent is slower than the rate of the Michael addition reaction between the polyurethane resin and the catalyst. In some other embodiments, one of the reactions (Michael addition or opening-ring) may take longer to complete than another simply because there are more reactants available for that reaction. The speed of reactions may be measured, for example, by FTIR by monitoring a change in the catalyst and a change in the curing agent over time. Such a “change” may be a change in structure or amount of a reactant, functional group, or byproduct (e.g., conversion of a double bond of acceptor for the Michael addition in the polyurethane resin; disappearance in oxirane in the epoxy resin, etc.) or a change in some other indicator that the reaction has progressed.

Because the opening-ring reaction and the Michael Addition reaction do not share reactants, there is not a concern that one reaction will occur too quickly and consume the reactants required by the other reaction. Thus, again, there is more flexibility in tuning the properties attributable to one resin without influencing the reaction mechanism of the other resin. Because each reaction can be individually controlled, the crosslinking density of each resin network can also be increased and controlled based on, for example, the amount and structure of each resin (epoxy or polyurethane) and each crosslinker (curing agent or catalyst). A higher crosslinking density can improve the mechanical and chemical properties of the two-part coatings system.

For the Michael addition reaction to occur, the polyurethane resin within the resin component, prior to mixing with the crosslinking component, comprises a donor and an acceptor for the Michael addition reaction. The donor may comprise an electronic-richer malonate polyester, malonic esters, or some other suitable nucleophile or enolate, and the acceptor may comprise electronic-deficient acryloyl monomers or oligomers or some other suitable electrophile or acryloyl. Additional non-limiting examples of donors that may be used in the polyurethane resin include β-diketones; β-ketoesters; β-keto nitriles; β-nitro ketones; α-nitro ketones; nitro compounds; and ethyl acetoacetate. Additional non-limiting examples of acceptors that may be used in the polyurethane resin include methyl acrylate; α, β-unsaturated aldehydes; α, β-unsaturated ketones; α, β-unsaturated esters; α, β-unsaturated amides; α, β-unsaturated nitriles; and nitroethylene.

In some embodiments, the polyurethane resin further comprises a hydrophobic, soft part configured to prevent crystallization of other hard parts of the chain and comprises a hydrophilic part configured to assist the polymer chains to disperse in water, as the polyurethane resin is a waterborne system. In some embodiments, the polyurethane functional group may be arranged between the hydrophobic part and the hydrophilic part of the polyurethane polymer chain. In some embodiments, the donor is arranged at a first end of the polyurethane polymer chain, while the acceptor is arranged at a second end of the polyurethane polymer chain. The polyurethane functional group, the hydrophobic part, and the hydrophilic part of the polyurethane polymer chain may be arranged between the first end and the second end of the polyurethane polymer chain. It will be appreciated that the polyurethane resin may comprise other functional groups within the polyurethane polymer chain given these other functional groups do not react with the epoxy resin or the curing agent of the crosslinking component. Additionally, any additional functional groups in the polyurethane resin preferably do not react with the catalyst of the crosslinking component such that the Michael addition reaction between the donors and acceptors in the polyurethane resin can still be controlled when mixed with the crosslinking component.

As a non-limiting example, in some embodiments, the polyurethane resin comprises de-ionized water as a primary solvent and an organic solvent as a co-solvent. Because water is the primary solvent, meaning because there is more water than organic solvent, the overall polyurethane resin is still considered waterborne. In one exemplary embodiment, the co-solvent may be dipropylene glycol dimethyl ether. In some embodiments, the polyurethane resin further comprises various dispersants, deformers, pigments, anti-rust agents, anti-corrosion agents, fillers, leveling agents, epoxy latex, rheology modifiers, binders, and the like.

In some embodiments, the catalyst in the crosslinking component comprises a base catalyst suitable for initiating the Michael addition reaction in the polyurethane resin. The catalyst may comprise, for example, tetramethyl guanidine (TMG); 1,5-diazabicyclo (4,3,0)non-5-ene (DBN); 1,8-diazabicyclo(5,4,0)undec-7-ene (DBU); triphenylphosphine; titanium tetrachloride; chrial amino-amide organo-catalysts; and dihalogen catalysts. To reduce the speed of the Michael addition reaction and thus, extend the potlife of the two-part coatings system, the catalyst in the crosslinking component may comprise a blocked base catalyst such as, for example, a tetraalkyl ammonium hydroxide species reacted with a dialkyl carbonate, combined with a kinetic control additive. In some embodiments, the potlife can be further manipulated based on the amount of the kinetic control additive included in the crosslinking component.

For the opening-ring reaction to occur, the epoxy resin comprises epoxide groups ready to react with the curing agent of the crosslinking group. It will be appreciated that the epoxy resin may comprise other functional groups within the epoxy polymer chain given these other functional groups do not react with the polyurethane resin or the catalyst of the crosslinking component. Additionally, any additional functional groups in the epoxy resin preferably do not react with the curing agent of the crosslinking component such that the opening-ring reaction between the amines in the curing agent and the epoxide groups in the epoxy resin can still be controlled when the resin component is mixed with the crosslinking component.

As a non-limiting example, in some embodiments, the epoxy resin comprises de-ionized water as a primary solvent and an organic solvent as a co-solvent. Because water is the primary solvent, meaning because there is more water than organic solvent, the overall epoxy resin is still considered waterborne. In one exemplary embodiment, the co-solvent may be dipropylene glycol dimethyl ether. In some embodiments, the epoxy resin further comprises various dispersants, deformers, pigments, anti-rust agents, anti-corrosion agents, fillers, leveling agents, epoxy latex, rheology modifiers, binders, and the like.

In some embodiments, the curing agent comprises amine functional groups. In some embodiments, the curing agent is aliphatic. In some other embodiments, the curing agent may be aromatic. An aliphatic amine-based curing agent may provide a faster reaction with the epoxy resin than an aromatic amine-based curing agent. It will be appreciated that the curing agent may comprise other functional groups within the amine polymer chain given these other functional groups do not react with the polyurethane resin or the curing agent of the crosslinking component. Additionally, any additional functional groups in the curing agent preferably do not react with the epoxide groups of the resin component such that the opening-ring reaction between the amines of the curing agent and the epoxide groups in the epoxy resin can still be controlled when the resin component is mixed with the crosslinking component.

In some embodiments, the curing agent may comprise primary amines, secondary amines, tertiary amines, multifunctional amines, polyamides, polyamidoamines, amino silanes, dimethylethanolamine, or combinations thereof. The amines may be aliphatic, cycloaliphatic, aromatic, or dicyandiamides, for example. Exemplary multifunctional amines used for the curing agent may be chose from aliphatic multifunctional amines, aromatic multifunctional amines or combinations thereof. Exemplary aliphatic multifunctional amines include polyethylene amines, for example diethylene triamine, triethylene tetraamine, tetraethylene pentaamine, pentaethylene hexamine, 1,6-hexamethylene diamine, 3,3,5-trimethyl-1,6-hexamethylene diamine, 3,5,5-trimethyl-1,6-hexamethylene diamine, 2-methyl-1,5-pentamethylene diamine, di-(3-aminopropyl)amine, N,N′-di-(3-aminopropyl)-1,2-ethylene diamine, N,N-dimethyl-1,3-propylene diamine, N,N-ethyl-1,3-propylene diamine, amino ethylpiperazine or combinations thereof. Exemplary aromatic multifunctional amines include ortho-toluene diamine, meta-toluene diamine, meta-phenylene diamine, methylene bridged di(phenylene)amine, and mixtures or combinations thereof. Additional non-limiting examples of possible curing agents include phenol- and amino-formaldehyde resins; carboxylic acid functional polyesters, anhydrides, polysulphides, and polymercaptans. Additionally, the crosslinking component may further include catalysts for curing of the epoxy resin such as, for example, tertiaryamines, imidazoles, ureas, hydrazine, and hydrazides. The aforementioned catalysts for epoxy curing may be used in addition to or in place of the curing agent in the crosslinking component. It will be appreciated that other curing agents and/or catalysts that are reactive with the epoxy resin but are unreactive with the polyurethane resin and unreactive with the catalyst are within the scope of this disclosure.

The two-part coatings system of the present invention may also include other optional ingredients that do not adversely affect the two-part coatings system or a cured coating resulting therefrom. Such optional ingredients include, for example, catalysts, dyes, pigments, toners, extenders, fillers, lubricants, anticorrosion agents, flow control agents, thixotropic agents, dispersing agents, antioxidants, adhesion promoters, light stabilizers, surfactants, and mixtures thereof. Each optional ingredient is preferably included in a sufficient amount to serve its intended purpose, but not in such an amount to adversely affect the two-part coatings system or a cured coating resulting therefrom. For example, these optional ingredients preferably do not promote crosslinking between the epoxy resin and the polyurethane resin in the resin component such that the resin component remains shelf-stable and are available for crosslinking to form the interpenetrating polymer network upon mixing with the crosslinking component. Similarly, these optional ingredients preferably do not promote reactions within the crosslinking component such that the crosslinking component also remains shelf-stable and enough of the curing agent and catalyst remain available for reactions when mixed with the resin component.

After the resin component and the crosslinking component are manufactured, each component may be stored for a long period of time and remain shelf-stable for the aforementioned reasons (e.g., the epoxy resin is substantially unreactive or more preferably not reactive with the polyurethane resin in the resin component; and the catalyst is substantially unreactive or more preferably not reactive with the curing agent in the crosslinking component). When a substrate is ready for coating, the resin component is mixed with the crosslinking component at a predetermined ratio. For example, in some embodiments, a ratio between the equivalent weight of epoxide groups in the epoxy resin to the amine groups in the curing agent may be in a range of between preferably about 1:5 and about 2:1, more preferably about 2:5 and about 1.5:1, or even more preferably about 3:5 to about 1:1. Further, in some embodiments, upon mixing the crosslinking component and the resin component, the mixture may comprise, for example, preferably between about 2% and about 12% of the catalyst, more preferably between about 2% and about 10% of the catalyst, even more preferably between about 3% and about 10% of the catalyst, or yet even more preferably between about 4% and about 6% of the catalyst. In some embodiments, a ratio of the weight of the catalyst to the weight of the polyurethane resin is in a range of, for example, about 1:30 to about 1:5. It will be appreciated that the ratio of functional groups and components within the two-part coatings system upon mixing may be tuned for desirable properties such as potlife, mechanical strength, adhesion, corrosion resistance, and the like.

The resin component and the crosslinking component may be mixed together using a paint stick, a bucket agitator, an electric mixing attachment, or some other suitable tool at room temperature. In some embodiments, the potlife of the mixture may be in a range of between about 1 hour and about 5 hours, which is significantly longer than common polyurethane coatings cured by isocyanates. More preferably, in some embodiments, the potlife of the mixture is greater than 3 days. The resulting mixture of the resin component and the crosslinking component may be applied to a prepared substrate as a coating via rolling, brushing, spraying, or some other suitable coating method. The coating may be applied at a thickness of between, for example, approximately 2 mils and approximately 5 mils. When blowing room temperature air at the substrate, the coating may dry on the substrate within 10 minutes at room temperature and with little to no tack. After about 1 hour of blowing room temperature air at the substrate, the coating may be cleaned and sanded. In some embodiments, the coating may be sanded using 320 grit and 600 grit sandpaper. Over time, the catalyst from the crosslinking agent promotes crosslinking amongst the polymers in the polyurethane resin through Michael addition reactions, and the curing agent promotes crosslinking amongst the polymers in the epoxy resin through opening-ring reactions. The interpenetrating polymer network, comprising a first polymer network of crosslinked epoxy intertangled with a second polymer network of crosslinked polyurethane, begins to form as these crosslinking reactions progress. The interpenetrating polymer network forms a hybrid epoxy-polyurethane coating over the substrate, and eventually, once all of the reactions are complete, this hybrid epoxy-polyurethane coating cures over the substrate.

In some embodiments, the substrate is prepared to receive the hybrid epoxy-polyurethane coating by first applying a waterborne etch primer coating to the substrate. A waterborne etch primer may be used because the hybrid epoxy-polyurethane coating is also waterborne. In some embodiments, the etch primer coating comprises an epoxy-polysiloxane network. In some embodiments, the substrate may comprise a metal (e.g., steel, aluminum, etc.), a plastic (e.g., thermoplastic or thermoplastic), a ceramic, or some other suitable material or composite material. In some embodiments, the hybrid epoxy-polyurethane coating may be applied directly to the substrate, whereas in some other embodiments, an etch primer coating or some other pretreatment of the substrate is applied prior to the application of the hybrid epoxy-polyurethane coating.

In some embodiments, the hybrid epoxy-polyurethane coating acts as a primer layer configured to receive an overlying coating. In some such embodiments, one or more overlying coatings such as a base coat, a clearcoat, and the like may be applied to the hybrid epoxy-polyurethane coating upon the full or partial curing of the hybrid epoxy-polyurethane coating. As a primer layer, the hybrid epoxy-polyurethane may be formulated to adhere to both the underlying substrate or coating and the overlying coatings. In some embodiments, adhesion to the underlying substrate or coatings, as well as adhesion to any overlying coatings, may be improved by adjusting the amount of hydrophilic parts in the polyurethane resin. For example, if an underlying or overlying coating is also waterborne, the hybrid epoxy-polyurethane coating may wet and thus, adhere better to the underlying or overlying coating when the hybrid epoxy-polyurethane coating has hydrophilic properties.

As a non-limiting example, in some embodiments an underlying etch primer layer that comprises, for example, an epoxy-polysiloxane network, is formed from a waterborne epoxy resin, amine curing agents, silane oligomer comprising hydroxyl and amine functional groups, and other suitable additives. Upon mixing these components, the etch primer layer is sprayed onto the substrate and can dry on the substrate within about 1 minute to about 25 minutes at room temperature and with little to no tack. The time to dry the etch primer layer may vary based on the temperature and humidity conditions. In some embodiments, the substrate is prepared to receive the epoxy-polysiloxane network by cleaning and sanding. Additionally, in some embodiments, the etch primer layer comprising the epoxy-polysiloxane network may be sanded prior to receiving the hybrid epoxy-polyurethane coating.

Other non-limiting examples of suitable organic solvents for use in the primarily waterborne coating compositions of the present invention include aliphatic hydrocarbons (e.g., mineral spirits, kerosene, VM&P NAPHTHA solvent, and the like); aromatic hydrocarbons (e.g., benzene, toluene, xylene, the SOLVENT NAPHTHA 100, 150, 200 products and the like); alcohols (e.g., ethanol, n-propanol, isopropanol, n-butanol, iso-butanol and the like); ketones (e.g., acetone, 2-butanone, cyclohexanone, methyl aryl ketones, ethyl aryl ketones, methyl isoamyl ketones, and the like); esters (e.g., ethyl acetate, butyl acetate and the like); glycols (e.g., butyl glycol); glycol ethers (e.g., ethylene glycol monomethyl ether, ethylene glycol monoethyl ether, ethylene glycol monobutyl ether, propylene glycol monomethyl ether, and the like); glycol ether esters (e.g., butyl glycol acetate, methoxypropyl acetate and the like); and mixtures thereof.

The following examples of improved properties of the hybrid epoxy-polyurethane coating are provided to illustrate the present invention and its advantages but should not be construed as limiting a scope of the invention.

In one embodiment, the following data was collected by comparing a conventional polyurethane coating to the hybrid epoxy-polyurethane coating disclosed herein. The hybrid epoxy-polyurethane coating samples for testing were prepared by sanding and cleaning a steel substrate; drying the steel substrate at room temperature; applying the waterborne epoxy-polysiloxane etch primer layer to the prepared substrate; applying the hybrid epoxy-polyurethane coating to the waterborne epoxy-polysiloxane etch primer layer; drying the hybrid epoxy-polyurethane coating; polishing and cleaning the hybrid epoxy-polyurethane coating; applying a black basecoat layer over the hybrid epoxy-polyurethane coating; and applying a clearcoat layer over the black basecoat layer. The control samples for testing were prepared similarly to the hybrid epoxy-polyurethane coating samples, except in the control samples, a solventborne etch primer was used instead of the waterborne epoxy-polysiloxane etch primer layer; and a conventional solventborne polyurethane coating was used instead of the waterborne hybrid epoxy-polyurethane coating.

In some embodiments, the dry film thickness of the waterborne epoxy-polysiloxane etch primer layer or solventborne etch primer layer is in a range of about, for example, 0.5 mil and about 1.5 mil. In some embodiments, the dry film thickness of the waterborne hybrid epoxy-polyurethane coating or solventborne polyurethane coating is in a range of about, for example, 3 mil and about 5 mil. In some embodiments, the dry film thickness of the black basecoat layer is in a range of about, for example, 0.5 mil and about 1.2 mil. In some embodiments, the dry film thickness of the clearcoat layer is in a range of about, for example, 3 mil and about 6 mil. It will be appreciated that other dry film thickness values may be used as long as ample drying time is allowed between coating of layers. Additionally, for the following data collection, corresponding layers in hybrid epoxy-polyurethane coating samples and the control samples had the same or similar dry film thicknesses to remove thickness as a variable from these test results.

In some embodiments, the chemical resistance of the hybrid epoxy-polyurethane coating can be tested by rubbing a paper soaked in methyl ethyl ketone (MEK) solvent on the substrate according to ASTM D5402-19. If the substrate is not exposed after 300 cycles of rubbing with MEK solvent, then the hybrid epoxy-polyurethane coating is considered to be “chemically resistance.” The hybrid epoxy-polyurethane samples and the conventional samples can both withstand at least 300 cycles and thus, are both sufficiently “chemically resistant.”

In some embodiments, the adhesive strength of the hybrid epoxy-polyurethane coating can be evaluated using crosshatch testing according to ASTM D3359. This test evaluates adhesive strength by applying and removing pressure-sensitive tape over cuts made in the coating. The substrate and coatings are monitored to see if the coatings peel away from the substrate and/or stick to the tape. Upon performing this adhesive strength test, both of the hybrid epoxy-polyurethane samples and the conventional samples had the same adhesive strength value.

In some embodiments, the impact resistance of the hybrid epoxy-polyurethane coating can be evaluated according to ASTM D5420. This test evaluates direct and non-direct impact strength of the coatings. Upon performing this impact resistance test, both of the hybrid epoxy-polyurethane samples and the conventional samples were able to withstand the same amount of pressure directly and indirectly. Stone chip testing was also be performed to evaluate coating durability, and the results were similar between the hybrid epoxy-polyurethane samples and the conventional samples.

In some embodiments, the film flexibility of the hybrid epoxy-polyurethane coating can be evaluated according to a conical mandrel bend test disclosed in ASTM D522. Upon performing this flexibility test, both of the hybrid epoxy-polyurethane samples and the conventional samples received a passing score, meaning both coatings exhibited a sufficient film flexibility for its intended applications.

In some embodiments, the optical appearance of the hybrid epoxy-polyurethane coating can be evaluated according to gloss retention at 20 degrees and/or distinctness of image (DOI) retention. Upon performing these optical appearance tests, both of the hybrid epoxy-polyurethane samples and the conventional samples had similar gloss and DOI scores, wherein the testing results were each about 5 percent of one another.

In some embodiments, the hybrid epoxy-polyurethane coating's behavior in humid and corrosive environments can be evaluated in a humidity chamber and in a salt fog chamber. For example, in a humidity chamber, the substrates coated with the hybrid epoxy-polyurethane coating and with the conventional solventborne polyurethane coating were evaluated after being exposed to an elevated temperature for several days. The change in optical appearance and adhesive strength can then be measured. In some embodiments, the hybrid epoxy-polyurethane coating's optical appearance and adhesive loss were slightly less favorable than the conventional solventborne polyurethane coating. This slightly worse behavior can be attributed to the fact that there is no chemical bonding between layers in contact with the hybrid epoxy-polyurethane coating. Because the cured coating shrinks when exposed to higher temperatures, without this chemical bonding, the hybrid epoxy-polyurethane coating may lose more adhesion to surrounding layers. It was observed that the optical appearance and/or adhesive loss of the hybrid epoxy-polyurethane coating after humidity testing were more slightly favorable than the conventional solventborne polyurethane coating when the ratio between the equivalent weight of epoxide groups to the amine groups in the hybrid epoxy-polyurethane coating increased from about 0.75:1 to about 1.5:1.

To test the coating's behavior in a corrosive environment, the substrates may be placed in a salt fog chamber at an elevated temperature for a few weeks. Prior to loading the substrates into the salt fog chamber, a scratch may be intentionally made into the hybrid epoxy-polyurethane coating and the conventional solventborne polyurethane coating. In some embodiments, the salt fog chamber testing is conducted in accordance with ASTM B117. After removing the substrates from the salt fog chamber, the amount of delamination and corrosion that occurred at the scratch is evaluated. The hybrid epoxy-polyurethane coating's delamination and corrosion amount were slightly less favorable than the conventional solventborne polyurethane coating. Again, this can be attributed to the little to no chemical bonding between the hybrid epoxy-polyurethane coating and surrounding layers on the substrate. It was observed that at least the corrosion of the hybrid epoxy-polyurethane coating after ASTM B117 were slightly more favorable than the conventional solventborne polyurethane coating when the ratio between the equivalent weight of epoxide groups to the amine groups in the hybrid epoxy-polyurethane coating increased from about 0.75:1 to about 1.5:1.

It can be appreciated that other test methods may be used to evaluate the above properties as well as other properties of each of the hybrid epoxy-polyurethane coating and the conventional solventborne polyurethane coating. Additionally, the above comparisons between the properties of hybrid epoxy-polyurethane coating and the conventional solventborne polyurethane coating are exemplary and may change depending on the exact formulation and/or application method of the hybrid epoxy-polyurethane coating over a substrate.

As evidenced by the above exemplary data, the hybrid epoxy-polyurethane coating had a faster drying time and better optical appearance compared to the conventional solventborne polyurethane coating. Other properties of the hybrid epoxy-polyurethane coating were mostly comparable to the conventional solventborne polyurethane coating. Thus, the disclosed waterborne hybrid epoxy-polyurethane coating has a lower amount of VOCs while providing similar or better properties than conventional solventborne polyurethane coatings.

The following are non-limiting examples of some embodiments of the present invention:

Embodiment 1. A two-part system comprising:
a resin component comprising an epoxy resin and a polyurethane resin; and
a crosslinking component comprising a curing agent and a catalyst,
wherein the polyurethane resin comprises a donor for a Michael addition reaction and an acceptor for a Michael addition reaction, wherein the catalyst is configured to facilitate a Michael addition reaction between the donor and the acceptor of the polyurethane resin, and wherein the curing agent is configured to react with the epoxy resin.

Embodiment 2. The two-part coatings system of Embodiment 1, wherein the curing agent comprises amines.

Embodiment 3. The two-part coatings system of one of Embodiments 1 or Embodiments 2, wherein the polyurethane resin comprises a hydrophobic portion and a hydrophilic portion.

Embodiment 4. The two-part coatings system of any one of Embodiments 1 to 3, wherein the resin component and the crosslinking component are configured to react to form a hybrid epoxy-polyurethane coating without using an isocyanate.

Embodiment 5. The two-part coatings system of any one of Embodiments 1 to 4, wherein the epoxy resin is configured to not react with the catalyst, and wherein the polyurethane resin is configured to not react with the curing agent.

Embodiment 6. The two-part coatings system of any one of Embodiments 1 to 5, wherein about 5 wt % to about 25 wt % of the resin component comprises the epoxy resin.

Embodiment 7. The two-part coatings system of any one of Embodiments 1 to 6, wherein the resin component is waterborne.

Embodiment 8. The two-part coatings system of any one of Embodiments 1 to 7, wherein the polyurethane resin is configured to react with the catalyst while the epoxy resin is configured to simultaneously react with the curing agent to form a hybrid epoxy-polyurethane coating comprising an interpenetrating polymer network.

Embodiment 9. The two-part coatings system of Embodiment 8, wherein the interpenetrating polymer network comprises a first polymer network and a second polymer network, wherein the first polymer network comprises crosslinked epoxy, wherein the second polymer network comprises crosslinked polyurethane.

Embodiment 10. The two-part coatings system of Embodiment 9, wherein the first polymer network is interlaced but not crosslinked with the second polymer network.

Embodiment 11. A two-part coatings system comprising:
a resin component comprising an epoxy resin and a polyurethane resin; and
a crosslinking component comprising a curing agent and a catalyst,
wherein the epoxy resin is reactive with the curing agent but unreactive with the catalyst,
wherein the polyurethane resin is reactive with the catalyst but unreactive with the curing agent, and
wherein upon mixing the resin component with the crosslinking component, the epoxy resin and the polyurethane resin are configured to react with the curing agent and the catalyst, respectively, to form an interpenetrating polymer network.

Embodiment 12. The two-part coatings system of Embodiment 11, wherein the resin component and the crosslinking component are waterborne.

Embodiment 13. The two-part coatings system of one of Embodiment 11 or Embodiment 12, wherein the polyurethane resin comprises a donor for a Michael addition reaction proximate, an acceptor for a Michael addition reaction, a hydrophobic part, a hydrophilic part, and a polyurethane functional group.

Embodiment 14. The two-part coatings system of any one of Embodiments 11 to 13, wherein the curing agent comprises amines.

Embodiment 15. The two-part coatings system of any one of Embodiments 11 to 14, wherein the epoxy resin is unreactive with the polyurethane resin, and wherein the catalyst is unreactive with the curing agent.

Embodiment 16. A method of forming a coating comprising:
mixing a resin component with a crosslinking component to form a mixture, wherein the resin component comprises an epoxy resin and a polyurethane resin, and wherein the crosslinking component comprises a curing agent and a catalyst,
applying the mixture of the resin component and the crosslinking component on a substrate; and
curing the mixture of the resin component and the crosslinking component to form a cured hybrid epoxy-polyurethane coating on the substrate, wherein the mixture cures as the curing agent reacts with the epoxy resin and the catalyst reacts with the polyurethane resin.

Embodiment 17. The method of Embodiment 16, wherein the curing agent comprises amines.

Embodiment 18. The method of one of Embodiment 16 or Embodiment 17, wherein the catalyst reacts with the polyurethane resin via a Michael addition reaction.

Embodiment 19. The method of any one of Embodiments 16 to 18, wherein the substrate is a metal, and wherein a waterborne etch primer coating is applied to the substrate before the mixture is applied to the substrate such that the mixture is applied directly on the waterborne etch primer coating over the substrate.

Embodiment 20. The method of Embodiment 19, wherein the waterborne etch primer coating is formed from a waterborne epoxy-polysiloxane primer.

Embodiment 21. The method of any one of Embodiments 16 to 20, wherein the mixture is waterborne.

Embodiment 22. The method of any one of Embodiments 16 to 21, wherein the mixture of the resin component and the crosslinking component is applied directly to the substrate.

Embodiment 23. The method of any one of Embodiments 16 to 22, wherein the substrate is metal, plastic, or a combination thereof.

All methods described herein can be performed in any suitable order unless otherwise indicated herein or otherwise clearly contradicted by context. The use of any examples, or language describing an example (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

While the embodiments discussed herein have been related to the coatings and methods discussed above, these embodiments are intended to be examples only and are not intended to limit the applicability of these embodiments to only those discussions set forth herein.

The above description is merely illustrative of several possible embodiments of various aspects of the present invention, wherein equivalent alterations and/or modifications will occur to others skilled in the art upon reading and understanding this specification and the annexed drawings. In addition, although a particular feature of the invention may have been disclosed with respect to only one of several embodiments, such feature may be combined with one or more other features of the other embodiments as may be desired and advantageous for any given or particular application.

Additional modifications and variations of the present invention are possible in light of the above teachings. It is therefore to be understood that within the scope of the appended claims, the invention may be practiced otherwise than as specifically described herein.

What is claimed is:

1. A two-part coatings system comprising:
a resin component comprising an epoxy resin and a polyurethane resin; and
a crosslinking component comprising a curing agent and a catalyst,
wherein the polyurethane resin comprises a donor for a Michael addition reaction and an acceptor for a Michael addition reaction, wherein the catalyst is configured to facilitate a Michael addition reaction between the donor and the acceptor of the polyurethane resin, and wherein the curing agent is configured to react with the epoxy resin.

2. The two-part coatings system of claim 1, wherein the curing agent comprises amines.

3. The two-part coatings system of claim 1, wherein the polyurethane resin comprises a hydrophobic portion and a hydrophilic portion.

4. The two-part coatings system of claim 1, wherein the resin component and the crosslinking component are configured to react to form a hybrid epoxy-polyurethane coating without using an isocyanate.

5. The two-part coatings system of claim 1, wherein the epoxy resin is configured to not react with the catalyst, and wherein the polyurethane resin is configured to not react with the curing agent.

6. The two-part coatings system of claim 1, wherein about 5 wt % to about 25 wt % of the resin component comprises the epoxy resin.

7. The two-part coatings system of claim 1, wherein the resin component is waterborne.

8. The two-part coatings system of claim 1, wherein the polyurethane resin is configured to react with the catalyst while the epoxy resin is configured to simultaneously react with the curing agent to form a hybrid epoxy-polyurethane coating comprising an interpenetrating polymer network.

9. The two-part coatings system of claim 8, wherein the interpenetrating polymer network comprises a first polymer network and a second polymer network, wherein the first polymer network comprises crosslinked epoxy, wherein the second polymer network comprises crosslinked polyurethane.

10. The two-part coatings system of claim 9, wherein the first polymer network is interlaced but not crosslinked with the second polymer network.

11. A two-part coatings system comprising:
a resin component comprising an epoxy resin and a polyurethane resin; and
a crosslinking component comprising a curing agent and a catalyst,
wherein the epoxy resin is reactive with the curing agent but unreactive with the catalyst,
wherein the polyurethane resin is reactive with the catalyst but unreactive with the curing agent, and
wherein upon mixing the resin component with the crosslinking component, the epoxy resin and the polyurethane resin are configured to react with the curing agent and the catalyst, respectively, to form an interpenetrating polymer network.

12. The two-part coatings system of claim 11, wherein the resin component and the crosslinking component are waterborne.

13. The two-part coatings system of claim 11, wherein the polyurethane resin comprises a donor for a Michael addition reaction proximate, an acceptor for a Michael addition reaction, a hydrophobic part, a hydrophilic part, and a polyurethane functional group.

14. The two-part coatings system of claim 11, wherein the curing agent comprises amines.

15. The two-part coatings system of claim 11, wherein the epoxy resin is unreactive with the polyurethane resin, and wherein the catalyst is unreactive with the curing agent.

16. A method of forming a coating comprising:
mixing a resin component with a crosslinking component to form a mixture, wherein the resin component comprises an epoxy resin and a polyurethane resin, and wherein the crosslinking component comprises a curing agent and a catalyst,
applying the mixture of the resin component and the crosslinking component on a substrate; and
curing the mixture of the resin component and the crosslinking component to form a cured hybrid epoxy-polyurethane coating on the substrate, wherein the mixture cures as the curing agent reacts with the epoxy resin and the catalyst reacts with the polyurethane resin.

17. The method of claim 16, wherein the curing agent comprises amines.

18. The method of claim 16, wherein the catalyst reacts with the polyurethane resin via a Michael addition reaction.

19. The method of claim 16, wherein the substrate is a metal, and wherein a waterborne etch primer coating is applied to the substrate before the mixture is applied to the substrate such that the mixture is applied directly on the waterborne etch primer coating over the substrate.

20. The method of claim 19, wherein the waterborne etch primer coating is formed from a waterborne epoxy-polysiloxane primer.

21. The method of claim 16, wherein the mixture is waterborne.

22. The method of claim 16, wherein the mixture of the resin component and the crosslinking component is applied directly to the substrate.

23. The method of claim 16, wherein the substrate is metal, plastic, or a combination thereof.
